(19) United States
(12) Patent Application Publication
(10) Pub. No.: US 2026/0097895 A1
(43) Pub. Date: Apr. 9, 2026

(54) THERMOFORMED SINGLE-PIECE CUP FOR CAPSULES THAT OPEN AUTOMATICALLY

(71) Applicant: GUALA DISPENSING FP S.P.A., Alessandria (IT)

(72) Inventor: Mauro MULVONI, Alessandria (IT)

(21) Appl. No.: 19/113,956

(22) PCT Filed: Oct. 19, 2023
(86) PCT No.: PCT/IB2023/060560

§ 371 Date: Mar. 21, 2025

(30) Foreign Application Priority Data
Oct. 25, 2022 (IT) 102022000022002

(51) Int. Cl. B65D 85/804; B29C 51/14; B29C 51/26; B29L 31/00; B32B 27/08; B32B 27/30; B32B 27/32; B32B 27/36; B65D 65/40; B65D 65/46

(52) U.S. Cl. CPC B65D 85/8052; B29C 51/14; B29C 51/266; B32B 27/08; B32B 27/306; B32B 27/32; B32B 27/36; B65D 65/40; B65D 65/466; B29K 2995/0067; B29L 2031/7132; B32B 2250/03; B32B 2250/24; B32B 2250/246; B32B 2250/40; B32B 2307/7163; B32B 2307/7244; B32B 2439/40; B32B 2439/70; B65D 2565/387

(57) ABSTRACT

A cup made of thermoformed plastics has on one side a bottom with an outlet opening defined by a nozzle, and on an opposite side an inlet opening defined by an outwardly protruding rim. The bottom is a wall with inner reliefs and outer reliefs. The inner reliefs define outer recesses, and the outer reliefs define inner recesses. The bottom has a plurality of radial outer reliefs arranged uniformly around the nozzle. Each radial outer relief defines a corresponding radial inner channel. Innovatively, the cup makes it possible to produce a capsule for correct delivery of beverages, without an internal insert.

The object present invention is a thermoformed cup, a production method for the thermoforming of a cup and a capsule for the preparation of soluble or infusion beverages obtained using this cup.

The cup of a capsule is the body in which there is contained the food substance to be infused or dissolved in order to prepare the beverage. The cup may be used for the manufacturing of a capsule for the packaging of concentrated products (e.g., in the form of powder, granules, leaves) in predetermined, single-use doses, for the impromptu preparation of beverages (such as tea, coffee, herbal teas, milk, chocolate, etc.) by means of the introduction, into said capsule, of a fluid under pressure (mostly hot water).

Within the sector, it is known to make cups from a polymer material by means of injection molding technology. This technology makes it possible to obtain very precise geometries, by virtue of the fact that the molten polymer material is injected under pressure into a mold and, by filling every crack and crevice of the same, it allows the geometry to be reconstructed exactly. When it is necessary to make a multilayer capsule, generally with an inner barrier layer, injection molding technology has some issues that are essentially associated with the correct and uniform distribution of the various layers of the multilayer.

Within the sector, it is known to make cups from a polymer material by thermoforming technology. This technology, even though it doubtlessly has advantages in terms of production simplicity and the correct arrangement of the layers of the multilayer, has some disadvantages associated with a non-constant and non-uniform distribution of the plastics material within the contours of the mold, which impede the implementation of intricate and complex geometries. Known cups that are made using thermoforming, when intended for capsules provided with their own opening means, require the use of internal inserts, created by means of injection molding, on which the means that are functional for the correct delivery of the beverage are arranged. This solution involves productivity and assembly complexities leading to notable increases in manufacturing costs.

The object of the present invention is to provide a cup for the manufacture of capsules for beverages which solves the drawbacks of the prior art whilst taking into account the needs of the industry.

This object is achieved by a cup having a bottom wall that, by means of a succession of inner reliefs and recesses forming corresponding outer recesses and reliefs, implements all of the functional means necessary for a capsule for the correct delivery of the beverage, without the need for an internal insert.

This object is achieved by a cup according to claim 1, by a manufacturing method for a cup according to claims 11 and 12 and by a capsule that is obtained using said cup according to claim 13. The dependent claims describe preferred embodiments of the invention.

The features and advantages of the cup and capsule according to the present invention will appear more clearly from the following description, made by way of an indicative and non-limiting example with reference to the accompanying figures, wherein:

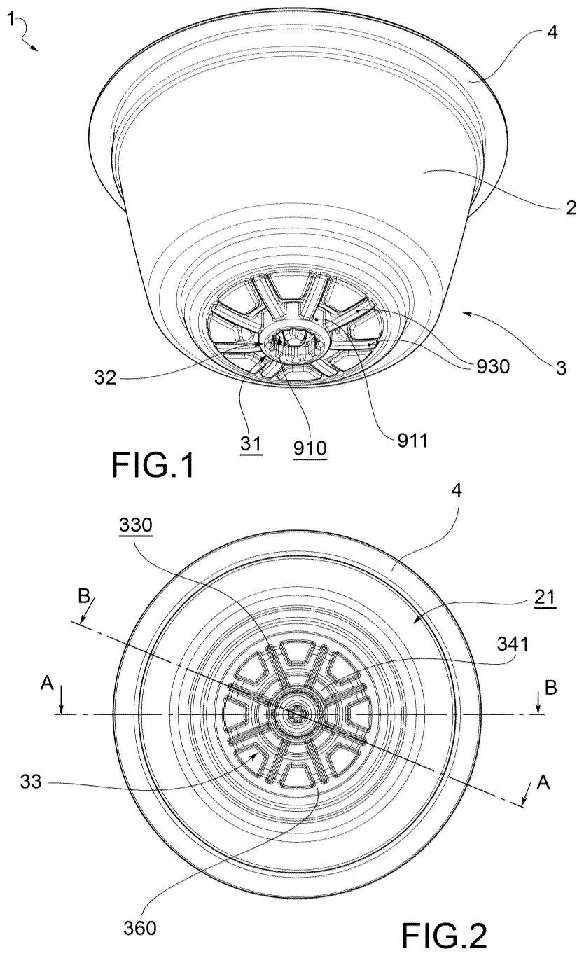

FIG. 1 is a perspective view of the bottom of a cup according to the present invention which may be used as a body of a capsule for the preparation of infusion or soluble beverages;

FIG. 2 is a top view of the inside of the cup of FIG. 1;

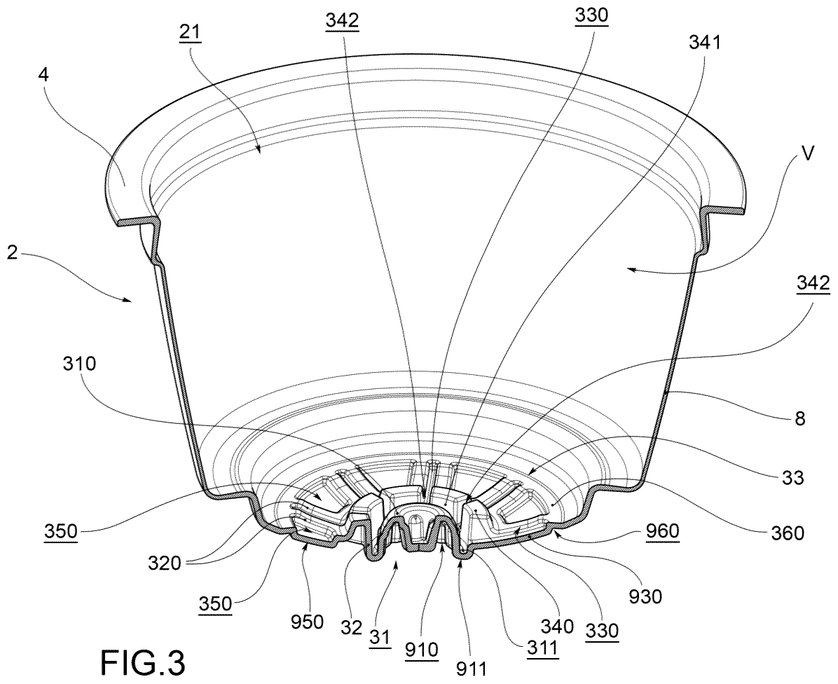

FIG. 3 is a sectional view of the cup in FIG. 1;

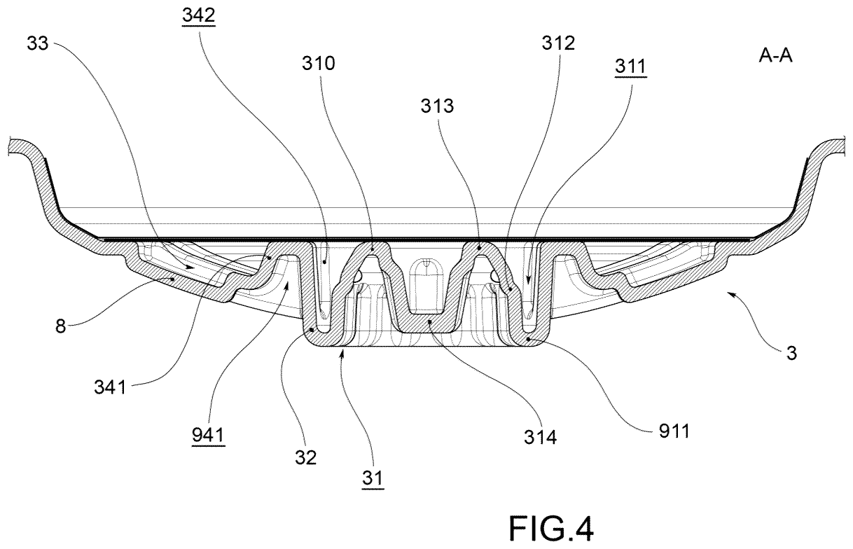

FIG. 4 is a sectional view of the inner portion of the bottom of the cup of FIG. 1, when used for the manufacture of a capsule;

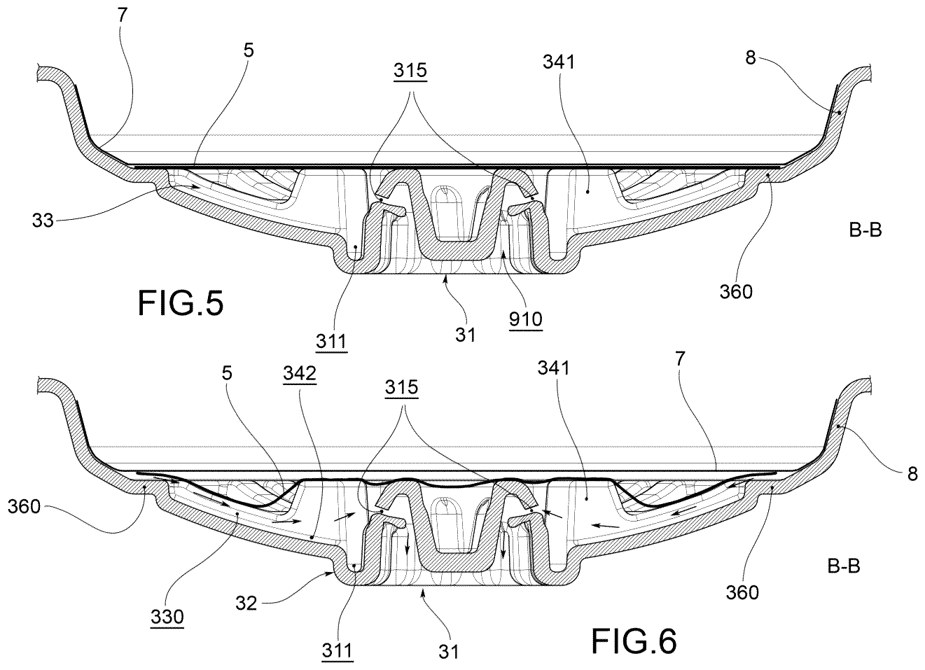

FIG. 5 is a sectional view of the inner portion of the bottom of the cup of FIG. 1, when used for the manufacture of a capsule, in a pre-delivery package;

FIG. 6 is a sectional view of the inner portion of the bottom of the cup of FIG. 1, when used for the manufacture of a capsule, in a post-delivery package;

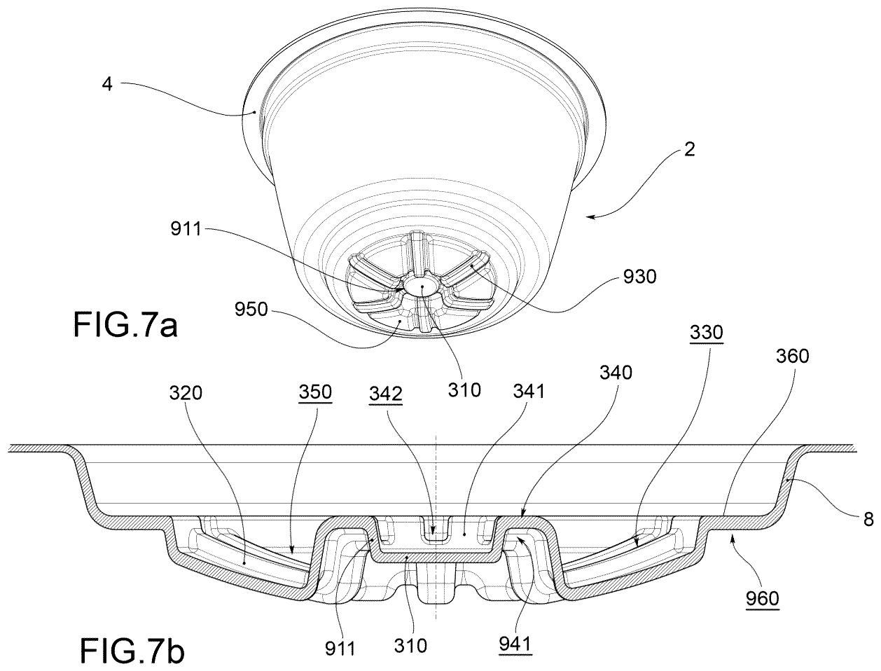

FIGS. 7A and 7B are, respectively, an axonometric view of the bottom and a sectional view of a cup according to the present invention which may be used as the body of a capsule for the preparation of infusion or soluble beverages, in a second embodiment, that requires a further processing step in order to form at least one outlet opening on the bottom;

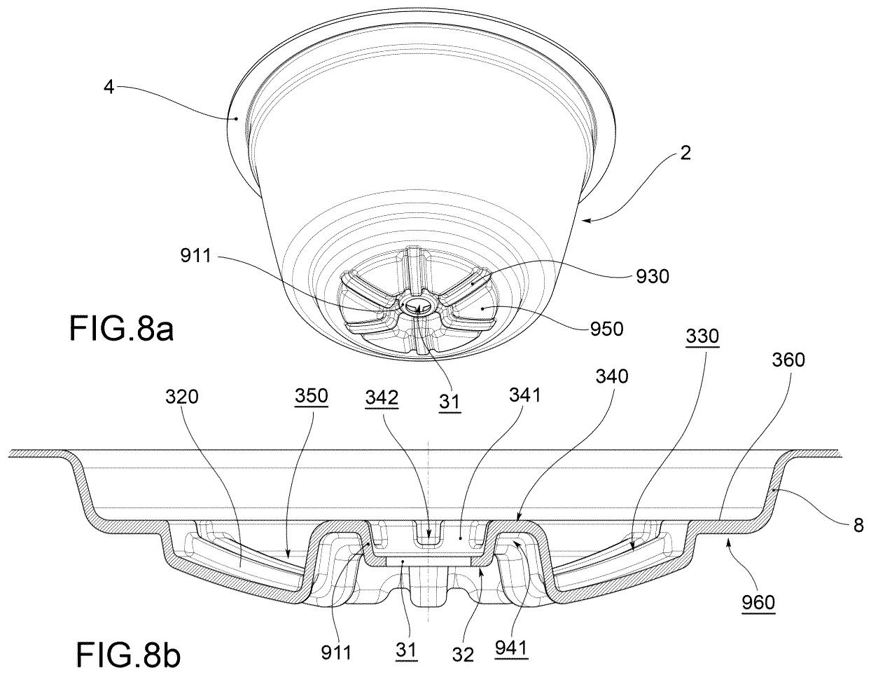

FIGS. 8A and 8B are, respectively, an axonometric view of the bottom and a sectional view of a cup according to the present invention which may be used as the body of a capsule for the preparation of infusion or soluble beverages, in a third embodiment, that is already provided with an outlet opening on the bottom;

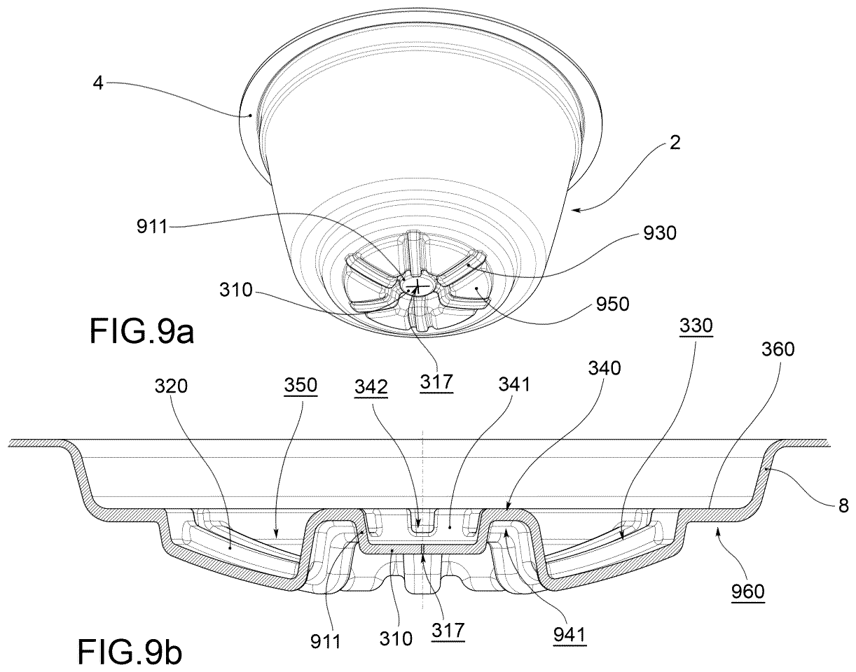

FIGS. 9A and 9B are, respectively, an axonometric view of the bottom and a sectional view of a cup according to the present invention which may be used as the body of a capsule for the preparation of infusion or soluble beverages, in a fourth embodiment, that again requires a further processing step in order to form at least one outlet opening on the bottom;

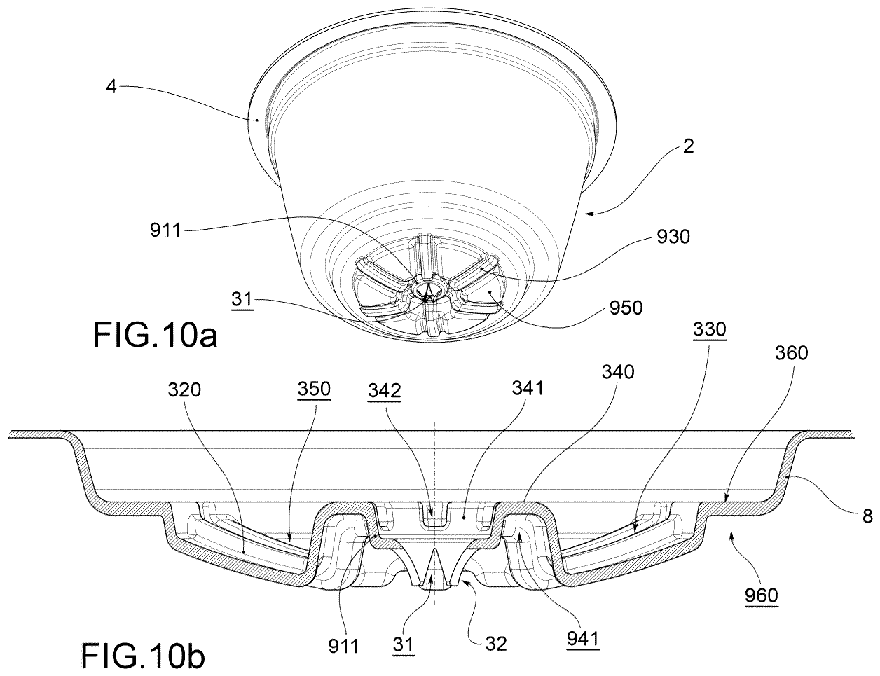

FIGS. 10A and 10B are, respectively, an axonometric view of the bottom and a sectional view of a cup according to the present invention which may be used as the body of a capsule for the preparation of infusion or soluble beverages, in a fifth embodiment, that is already provided with an outlet opening on the bottom;

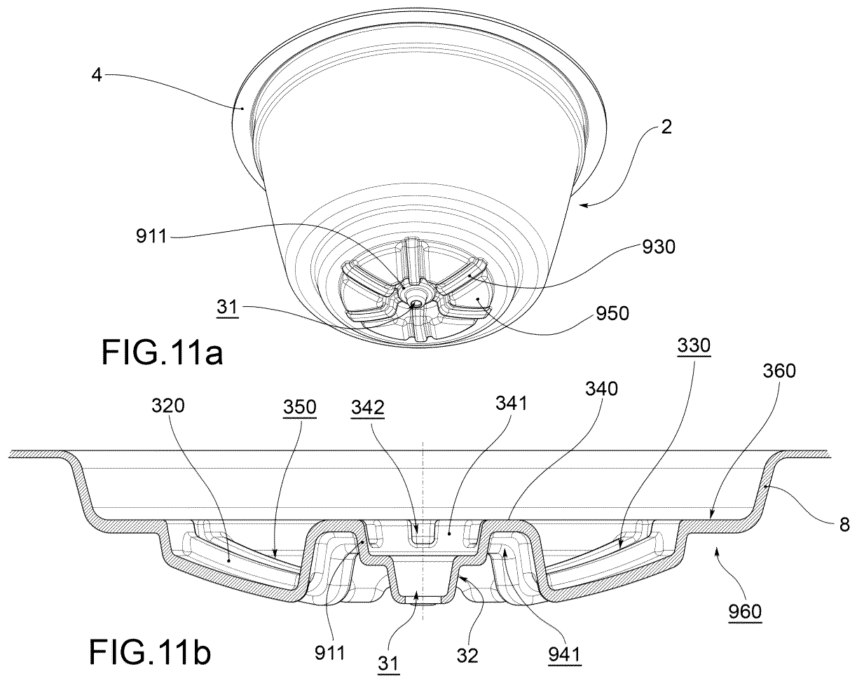

FIGS. 11A and 11B are, respectively, an axonometric view of the bottom and a sectional view of a cup according to the present invention which may be used as the body of a capsule for the preparation of infusion or soluble beverages, in a sixth embodiment, that is already provided with an outlet opening on the bottom;

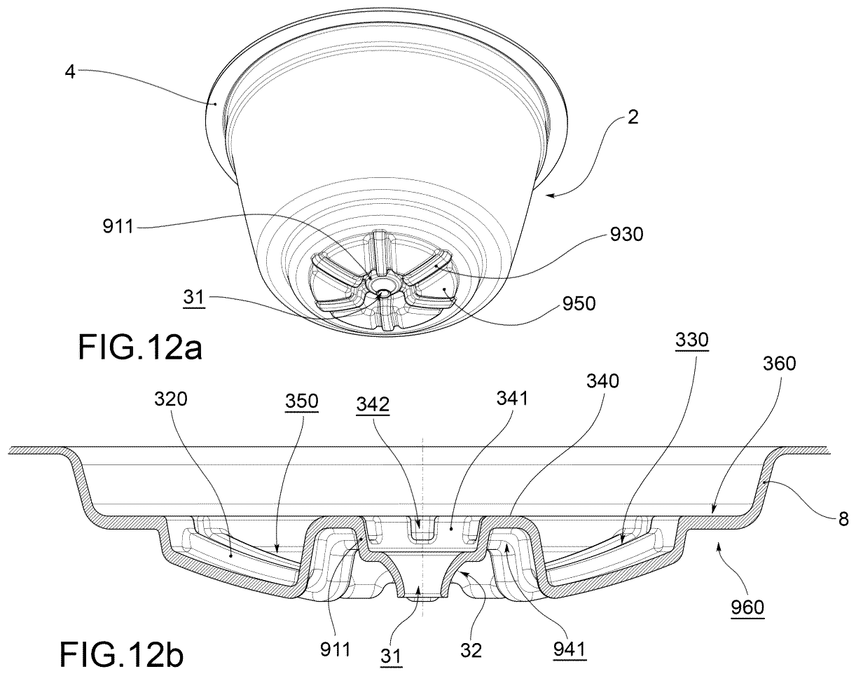

FIGS. 12A and 12B are, respectively, an axonometric view of the bottom and a sectional view of a cup according to the present invention which may be used as the body of a capsule for the preparation of infusion or soluble beverages, in a seventh embodiment, that is already provided with an outlet opening on the bottom.

With reference to the accompanying figures, the reference numeral 2 indicates a cup adapted to define an internal volume V for containing at least one substance to be infused or dissolved, typically in powder or granular form.

Said cup 2 may be used for manufacturing a capsule for preparing infusion or soluble beverages, which capsule is indicated with the reference numeral 1.

The cup 2 is made of a plastics material, thermoforming.

The cup 2 is provided on one side with a bottom 3 and on the opposite side with an inlet opening 21 defined by an externally projecting rim 4.

The cup 2 is provided externally, at the bottom 3, with an outlet opening 31 which is defined by a nozzle 32 and suitable for allowing the infused beverage to flow out.

The bottom 3 is concave and defines a funnel-shaped structure that facilitates the outflow of the beverage towards the outlet opening 31.

The bottom 3 is provided, internally, with a plurality of inner reliefs, some radial (320) and some circumferential (310, 340, 360), protruding vertically towards the inside of the cup 2. The circumferential inner reliefs act as supports for a sealing disc 5 insofar as they define, at the top thereof, an attachment plane for this disc. The radial inner reliefs act as ridges to prevent the sealing disc 5, during the step of opening the capsule in order to pour out the beverage, from completely adhering to the bottom 3.

The bottom 3 is also provided with a plurality of inner recesses (311, 330, 350) that define concavities facing towards the interior of the cup 2, which are necessary for the collection of the beverage (for example the circumferential recesses) and the correct outflow of the same towards the outlet opening 31 (for example the radial recesses).

The bottom 3 of the cup 2 is also provided with a plurality of outer reliefs, some radial (930, 950) and some circumferential (911), protruding vertically towards the outside of the cup 2. The radial outer reliefs, for example, form reinforcement ribs of the bottom 3. The circumferential outer reliefs, for example, form the nozzle 32 or supports for a proper abutment of the cup 2 within the infusion chamber of the machine.

The bottom 3 is also provided with a plurality of outer recesses (910, 941, 960) that define concavities facing the outside of the cup 2.

As may be seen from the cross-section of FIG. 3, the bottom 3 of the cup 2 is defined by a wall 8 that has substantially the same thickness, and that is characterized by alternating reliefs and recesses. It is noted that the wall of the bottom 3 that defines an inner relief is the same wall of the bottom 3 that defines an outer recess.

The inner reliefs of the bottom 3 are internally hollow, in such a way that, at an inner relief, an outer recess is made. In fact, at every inner relief of the bottom 3 there is a corresponding outer recess. And conversely: at every outer relief of the bottom 3 there is a corresponding inner recess. The geometry of an inner relief substantially corresponds to the geometry of the relevant outer recess.

The bottom 3 is completely free of sharp edges and has only radiating surfaces. All of the reliefs of the bottom 3, both inner reliefs and outer reliefs, are free of sharp edges. All of the recesses of the bottom 3, both inner recesses and outer recesses, are free of sharp edges. All of the reliefs of the bottom are provided with an external radius of between 0.3 and 0.5 mm.

In one example, shown in FIG. 3, the bottom 3 comprises a central portion 310, of a preferably annular shape. At the central portion 310, which is a relief, there is a corresponding central outer recess 910, on the outer side of the bottom 3, that forms the inside of the nozzle 32. As may be seen in FIG. 4, the central portion 310 comprises a perimeter 312 provided with holes 315 for the beverage to flow towards the outlet opening 31, a flat upper portion 313 that forms an abutment for the attachment of a sealing disc 5, and a central pin 314 that extends into the nozzle 32.

The nozzle 32 is defined by a central outer relief 911, preferably of an annular shape, that defines, at one end thereof, the outlet opening 31 of the nozzle 32. At the central outer relief 911, on the inner side of the bottom 3, there is a central inner collection recess 311.

The bottom 3 comprises a peripheral annular inner relief 360, planar at the top, on which it is possible to attach a sealing disc 5. At the peripheral inner relief 360, on the outer side of the bottom 3, an annular outer recess 960 is formed.

The bottom 3 comprises a central annular inner relief 340 that opposes the uncontrolled outflow of the beverage towards the outlet 31. The central inner relief 340 is formed from a plurality of banks 341, arranged transversely to the direction of the outflow of the beverage, interspersed with apertures 342 that allow for a controlled outflow of the beverage towards the central inner collection recess 311. The banks 341 have a box shape, and are internally empty. At a bank 341 that protrudes towards the interior of the cup 2, on the outer side of the bottom 3, a chamber 941 is made.

The bottom 3 comprises a plurality of radial outer reliefs 930, uniformly arranged around the nozzle 32, that form reinforcement ribs of the bottom 3 of the cup 2. As may be seen in FIG. 1, the radial outer reliefs 930 extend from the nozzle 32 up to the annular outer recess 960.

At each radial outer relief 930, internally to the cup 2, there is a radial inner channel 330 that is suitable for conveying the beverage towards the nozzle 32. Each radial inner channel 330 extends from the peripheral inner relief 360. Each radial inner channel 330 is arranged at an aperture 342 and flows into the central inner collection recess 311; in such a way as to form a free path (indicated with the arrow in FIG. 6) for the correct outflow of the beverage.

On both sides of one radial inner channel 330 there extend two inner ridges 320, each defined by a radial inner relief, that are suitable for preventing the sealing disc 5 from completely adhering to the bottom 3 of the cup 2 during the step of opening the capsule.

The bottom 3 comprises a plurality of outer supports 950 arranged uniformly around the annular outer recess 960, suitable for allowing the bottom 3 of the cup 2 to sit properly within the infusion chamber of the extraction machine. As may be seen in FIG. 1, the outer supports 950 have a substantially trapezoidal shape. At one outer support 950, internally to the bottom, a substantially trapezoidal inner basin 350 is formed. The basin 350 is arranged between two inner ridges 320.

The cup 2 is a single element, therefore a single piece, made by thermoforming.

In one embodiment, the cup 2 is a single material.

In a different embodiment, the cup 2 has a multilayer wall, having an outer layer, an inner layer intended to come into contact with the food substance, and an intermediate layer of the barrier type. In this embodiment, the intermediate layer forms a barrier to gases, in particular to oxygen. Preferably, the intermediate layer is made of ethylene-polyvinyl alcohol (EVOH) or polyvinyl alcohol (PVOH). Preferably, both the outer layer and the inner layer are made of polypropylene (PP), or polyethylene (PE), or polylactic acid (PLA). In one exemplary embodiment (PP-EVOH-PP), the cup 2 is multilayer, consisting of an outer layer made of polypropylene, an intermediate barrier layer made of ethylene-polyvinyl alcohol, and an inner layer made of polypropylene. In a different exemplary embodiment (PE-EVOH-PE), the cup 2 is multilayer, consisting of an outer layer made of polyethylene, an intermediate barrier layer made of ethylene-polyvinyl alcohol, and an inner layer made of polyethylene. Preferably, therefore, the material that forms the inner layer and the outer layer is a non-barrier material, belonging to the family of polyolefins, of the inert and food-compatible type.

Preferably, the cup 2 is biodegradable and compostable. In one exemplary embodiment, the cup 2 is multilayer, consisting of an outer layer made of polylactic acid, an intermediate barrier layer made of polyvinyl alcohol, and an inner layer made of polylactic acid (PLA-PVOH-PLA). In a further exemplary embodiment, other materials may be used from the family of polyhydroxyalkanoates (such as PHA, PHB, PHBH, etc.) , both as a single material and in combination with barrier materials (PVOH).

The cup 2 is made by thermoforming, starting with a single sheet of polymer material. The manufacturing method of the cup 2 includes, by thermoforming, making the bottom 3 as a wall 21, of a substantially uniform thickness, comprising reliefs and recesses, in such a way that, for each outer relief of the bottom 3, a corresponding inner recess is made, and, for each inner relief of the bottom 3, a corresponding outer recess is made. Advantageously, some outer reliefs constitute reinforcements for the bottom 3 and at the same time form inner recesses for the correct outflow of the beverage.

In one exemplary embodiment, the manufacturing method of the cup 2 includes a first step for the thermoforming of a single body, without interruptions nor openings within the wall. At the end of this first step, the cup 2 has a completely closed central portion 310 that completely seals the opening 31. In this example, the manufacturing method of the cup 2 includes a subsequent step of shearing (or cutting or perforation) of the central portion 310 in order to form holes 315 in said central portion 310.

In the example of FIG. 3, following the shearing step, the central portion 310 has a plurality of connection openings 315 between the interior of the cup 2 and the outlet opening 31 in order to allow the infused beverage to flow towards the outside of the capsule 1.

In the example of FIG. 8A, following the shearing step, the central portion 310 directly has an outlet opening 31 in order to allow the infused beverage to flow towards the outside of the capsule 1.

In the example of FIGS. 9A and 10A, the shearing step is performed by means of ultrasound or hot mechanical drilling and, after having made a central cut 317 (FIG. 9A), deforms the walls of the central portion 310 so as to obtain a nozzle 32 with a discontinuous funnel (FIG. 10A), directly terminating in an outlet opening 31 in order to allow the infused beverage to flow towards the outside of the capsule 1.

In the example of FIGS. 11A and 12A the shearing step is performed by means ultrasound or hot mechanical drilling and deforms the walls of the central portion 310 such as to obtain a nozzle 32 with a continuous funnel, directly terminating in an outlet opening 31 in order to allow the infused beverage to flow towards the outside of the capsule 1.

Therefore, in summary, this example of a manufacturing method includes the steps of:
making a cup 2 by thermoforming from a plastics material, preferably multilayer, of the gas barrier type; said cup 2 being a single body provided with an inlet opening 21 and, on the opposite side, a bottom 3 provided with a nozzle 32; said cup 2 having an inner base 33 comprising a completely closed central portion 310 covering the nozzle 32;
performing at least partial shearing of the central portion 310 in order to form a plurality of holes 315 connecting the interior of the cup 2 and the nozzle 32.

In a further exemplary embodiment, the method for manufacturing the cup 2 includes, by thermoforming, making a single body that is already provided with an outlet opening 31 in the bottom 3. Therefore, in a single step, the cup 2 already has a central portion 310 provided with an outlet opening 31 for the beverage to flow towards the outside of the capsule 1, as in FIGS. 8A, 10A, 11A, 12A.

Therefore, in summary, this example of a manufacturing method includes making a cup 2 by thermoforming; said cup 2 being a single body provided with an inlet opening 21 and, on the opposite side, a bottom 3 provided with a nozzle 32; said cup 2 having an inner base 33 comprising a central portion 310 with an outlet opening 31.

This cup 2 may be used for producing a capsule 1 for preparing an infused or soluble beverage.

The capsule 1 comprises a cover that is attached, by gluing or welding, at the upper edge 4, which cover is adapted to seal the cup 2 at the top. Preferably, the cover is made of a plastics material, multilayer or single-layer, or of a plastics/aluminum composite material.

The capsule 1 is internally provided with a sealing disc 5, internally attached to the bottom 3 and adapted to seal the cup 2 at the bottom. The sealing disc 5 is only shown in the FIGS. 4 to 6, but is equally applicable to all embodiment variants of the cup 2 described above and shown in the FIGS. 7A to 12B.

The capsule 1 is then provided with a closed chamber, defined at the top by the cover 6 and at the bottom by the disc 5, in which the substance to be infused or dissolved is contained. The presence of a hermetically closed chamber is important for the good preservation and conservation of the substance. The disc 5 is positioned beneath the food substance and above the bottom 3.

Preferably, the disc 5 is made of a plastics material, multilayer or single-layer, or of a plastics/aluminum composite material.

The disc 5 is internally attached to the cup 2 at the bottom 3, on the peripheral inner relief 360 and on the banks 341. In particular, the disc 5 is welded using a thermo-activatable material (a lacquer, a glue, or a polymeric bottom layer in the case of a multilayer disc).

In one exemplary embodiment, the disc 5 is permanently attached to the banks 341 instead with a low level of adhesion at the peripheral inner relief 360 in such a way as to detach, i.e., come unglued, therefrom due to the effect of the increase in temperature and pressure within the capsule 1, as in FIG. 6.

In one exemplary embodiment, the disc 5 is permanently attached both on the banks 341 and on the peripheral inner relief 360, and the opening of the capsule is obtained by collapsing the disc 5 due to the increase in pressure within the capsule 1. In one variant, the disc 5 is fragile and tears itself apart by collapsing following the increase in pressure within the capsule 1. In a further variant, the disc 5 has weaknesses, such as cuts or incisions that lead to the tearing of the disc 5 due to the effect of the increase in pressure within the capsule 1.

The capsule 1 may be made in different versions, for example for the preparation of infusion beverages (such as coffee) or soluble beverages.

Preferably, the capsule 1 for coffee comprises a filter 7 attached, beneath the substance, at the inner walls of the cup 2, just above the disc 5. The presence of the filter, preferably made of paper or fabric or non-woven fabric (TNT), allows the infused liquid to be filtered before emerging from the capsule 1.

Preferably, the capsule 1 for coffee further comprises a permeable or micro-perforated film, attached at a certain distance above the substance. The presence of this film, which allows the passage of the fluid under pressure but not the passage of the substance, prevents the dispersion of the coffee powder during the infusion step, improving the quality of the infused beverage.

In the case of a capsule for the preparation of soluble beverages, such as for example chocolate or milk, the capsule 1 comprises the cover 6 and the sealing disc 5, and is devoid of the filter and of the permeable or micro-perforated film.

The capsule 1, in its various embodiments, may be used for the extemporaneous preparation of beverages (such as tea, coffee, herbal teas, milk, chocolate, etc.) by means of automatic or semi-automatic machines provided with a dispensing group adapted to produce an infusion by the passage of hot water under pressure through the capsule 1.

In use therefore, the capsule 1 is inserted into a special location (said infusion chamber) included within the machine. The machine perforates the cover 6, positioned so as to close the capsule 1, and inserts a fluid under pressure (mostly hot water) into the chamber in which the substance is contained. The presence of the sealing disc 5 closing the bottom 3 of the capsule 1 allows the pressurized fluid to remain for a certain time interval in contact with the substance to be infused or dissolved, in such a way as to ensure that an optimal beverage is obtained. The pressure exerted by the fluid inside the capsule 1 rises until it reaches an opening pressure (for example between 4 and 8 bars), which pushes against the disc 5 until the capsule 1 is opened. In the example of FIG. 6, the opening of the capsule 1 is determined by the at least partial detachment of the disc 5 from the peripheral inner relief 360. This detachment weakens the previously ensured sealing effect on the part of the sealing disc 5. Conversely, in the example of FIG. 5, the opening of the capsule 1 is determined by the at least partial tearing of the disc 5, which tearing weakens the previously ensured sealing effect on the part of the sealing disc 5.

A capsule according to this invention may be used for packaging concentrated products (in the form of powder or granules or leaves) in predetermined, single-use doses, for the impromptu preparation of beverages such as leaf or soluble tea, ground or instant coffee, herbal teas, milk, chocolate, or other dehydrated and soluble products.

Innovatively, the thermoformed cup according to the present invention has a bottom wall that, by means of a succession of inner reliefs and recesses forming corresponding outer recesses and reliefs, makes it possible to produce a capsule that is provided with the necessary functional means for the correct delivery of the beverage. Advantageously therefore, the cup according to the present invention, despite being made by thermoforming, does not require any internal insert. This makes it possible to simplify the manufacturing and assembly thereof, thereby reducing production costs.

It is clear that those skilled in the art may make changes to the cup, to the capsule and to the method described above, all falling within the scope of protection as defined in the following claims.

What is claimed is:

1. A cup made of thermoformed plastics, comprising a bottom with an outlet opening defined by a nozzle on one side and an inlet opening defined by an outwardly protruding rim on an opposite side,
wherein the bottom is a wall with inner reliefs and outer reliefs, and wherein the inner reliefs define outer recesses, and the outer reliefs define inner recesses
and wherein the bottom comprises a plurality of radial outer reliefs, uniformly arranged around the nozzle, and each radial outer relief defines a corresponding radial inner channel.

2. The cup of claim 1, wherein the bottom is free from sharp edges and has all radial surfaces.

3. The cup of claim 1, wherein the bottom is concave and defines a funnel-shaped structure.

4. The cup of claim 1, wherein two inner ridges, each defined by a radial inner relief of the bottom, extend on either side of a radial inner channel.

5. The cup of claim 1, wherein the bottom comprises a central outer relief forming the nozzle.

6. The cup of claim 1, wherein the bottom comprises a central inner relief consisting of a plurality of banks interspersed with apertures.

7. The cup of claim 6, wherein the radial inner channels are aligned with the apertures.

8. The cup of claim 1, wherein the bottom comprises a plurality of outer supports and wherein each outer support of the plurality of outer supports defines an inner basin of the bottom.

9. The cup of claim 1, wherein the bottom comprises at least two concentric, circumferential inner reliefs provided with a flat top.

10. The cup of claim 1, having a multilayer wall with an outer layer, an inner layer, and an intermediate barrier layer, which forms a gas barrier.

11. A method of manufacturing a cup for a capsule for preparing a beverage, the method comprising:
manufacturing a cup comprising a bottom with an outlet opening defined by a nozzle on one side and an inlet opening defined by an outwardly protruding rim on an opposite side, wherein the bottom is a wall with inner reliefs and outer reliefs, wherein the inner reliefs define outer recesses, and the outer reliefs define inner recesses, and wherein the bottom comprises a plurality of radial outer reliefs, uniformly arranged around the nozzle, and each radial outer relief defines a corresponding radial inner channel, by thermoforming from a sheet of polymer material; and
after thermoforming, making a plurality of holes connecting an interior of the cup and the nozzle in a central portion of the bottom.

12. A method of manufacturing a cup for a capsule for preparing a beverage, the method comprising:
manufacturing a cup comprising a bottom with an outlet opening defined by a nozzle on one side and an inlet opening defined by an outwardly protruding rim on an opposite side, wherein the bottom is a wall with inner reliefs and outer reliefs, wherein the inner reliefs define outer recesses, and the outer reliefs define inner recesses, and wherein the bottom comprises a plurality of radial outer reliefs, uniformly arranged around the nozzle, and each radial outer relief defines a corresponding radial inner channel, by thermoforming from a sheet of polymer material; and
after thermoforming, making the outlet opening in a central portion of the bottom.

13. A capsule for preparing a beverage, comprising:
the cup of claim said cup containing a food substance for producing the beverage;
a lid tightly attached at the outwardly protruding rim of the cup; and
an inner sealing disc attached to the bottom of the cup below the food substance.
